(19) United States
(12) Patent Application Publication
(10) Pub. No.: US 2003/0140016 A1
(43) Pub. Date: Jul. 24, 2003

(54) Mailer-ID

(76) Inventors: Philip Grotsky, Yavne (IL); Dan Grotsky, Cambridge, MA (US); Baruch Atzmon, Ra'anana (IL); Ariel Spivak, Yavne (IL)

Correspondence Address: WELSH & KATZ, LTD, 120 S RIVERSIDE PLAZA, 22ND FLOOR, CHICAGO, IL, 60606, US

(21) Appl. No.: 10/310,577

(22) Filed: Dec. 5, 2002

Related U.S. Application Data
(60) Provisional application No. 60/339,553, filed on Dec. 10, 2001.

(51) Int. Cl. G06F 17/00; H04K 1/00

(52) U.S. Cl. 705/408; 705/62; 705/401

(57) ABSTRACT

A method for providing postal services including providing a postal substrate to a user, the postal substrate bearing an identification of the user and sending the postal substrate bearing the user's identification to a destination indicated by the user.

### FIELD OF THE INVENTION

The present invention relates to apparatus and methods for providing postal services.

### BACKGROUND OF THE INVENTION

Conventional automatic identification services used in state of the art postal systems are described in the following publications: U.S. Pat. No. 4,819,240; U.S. Pat. No. 5,602,382; US Postal Service Handbook DM 701—Procedures for Mailer Applications; United States Postal Service Publication 227—Preparing Packages for Mailing.

The disclosures of all publications mentioned in the specification and of the publications cited therein are hereby incorporated by reference.

### SUMMARY OF THE INVENTION

The present invention seeks to provide an improved system and method for providing postal services.

The system shown and described herein is advantageous in order to combat bio-terrorism and chemical terrorism via postal services. By uniquely identifying the sender of each and every mailpiece (i.e. any envelope, parcel, package, etc. sent via a postal service) worldwide, authorities may be better equipped to track the origins of, hence combat, bio- and chemical-terrorism.

According to a preferred embodiment of the present invention, the sender of mailpieces is automatically identified. In conventional postal service systems which provide automatic identification of address locator, machine identification or certain customer information and service information, attention has not been given to the desirability for identifying the sender of mailpieces.

Sender identification is common in state-of-the-art electronic mail and telephony (Caller-ID) systems, however such is not the case regarding postal service. Postal service, a much more traditional (and far older) delivery medium, has never been concerned with sender identification. However, sender identification would be advantageous in order to combat the use of postal service as a means of delivering dangerous, even lethal, substances by mail.

Security authorities throughout the western world are preoccupied with the threat of distributing dangerous substances by traditional mail. Enforcing identification of mail senders may facilitate effective tracking of suspicious mailpieces, thereby deterring individuals from sending them and/or facilitating monitoring and apprehension of those individuals not deterred.

There is thus provided in accordance with a preferred embodiment of the present invention, a method for providing postal services including providing a postal substrate to a user, the postal substrate bearing an identification of the user and sending the postal substrate bearing the user's identification to a destination indicated by the user.

Further in accordance with a preferred embodiment of the present invention, the postal substrate comprises one of the following postal substrates: a postage stamp, a postcard, an airletter, a prepaid envelope, a mailing label, and cardboard packaging.

Additionally in accordance with a preferred embodiment of the present invention, the identification comprises verifiable information and the step of sending comprises accepting the postal substrate from an individual and verifying correspondence between the verifiable user's identification and the individual.

Further in accordance with a preferred embodiment of the present invention, the verifiable information comprises “what you are” information such as biometric information.

Still further in accordance with a preferred embodiment of the present invention, the verifiable information comprises “what you have” information.

Further in accordance with a preferred embodiment of the present invention, the verifiable information comprises “what you know” information.

Also provided, in accordance with another preferred embodiment of the present invention, is a system for providing postal services including an ID-bearing postal substrate provider operative to provide a postal substrate bearing a user identification.

Further in accordance with a preferred embodiment of the present invention, the system comprises a postal substrate verifier operative to selectively authorize for sending, only postal substrates bearing verified user identification information.

Still further in accordance with a preferred embodiment of the present invention, the system comprises a postal substrate validator and router operative to receive and validate postal substrates and to route for sending only postal substrates bearing valid user identification.

Further in accordance with a preferred embodiment of the present invention, the postal substrate comprises one of the following postal substrates: a postage stamp, a postcard, an airletter, a prepaid envelope, a mailing label, and cardboard packaging.

Still further in accordance with a preferred embodiment of the present invention, the identification comprises human-readable identification information.

Additionally in accordance with a preferred embodiment of the present invention, the identification comprises machine-readable identification information.

Further in accordance with a preferred embodiment of the present invention, the identification comprises at least one of the following types of verifiable information: an employer ID number (EID), “what you are” information, biometric information, “what you have” information, and “what you know” information.

### BRIEF DESCRIPTION OF THE DRAWINGS

The present invention will be understood and appreciated from the following detailed description, taken in conjunction with the drawings in which:

FIG. 1 is a simplified block diagram of a mailer-ID marking system, constructed and operative in accordance with a preferred embodiment of the present invention, for affixing to a postal substrate a marking which identifies a mailer associated with the postal substrate;

FIG. 2 is a simplified block diagram of a mail routing system, constructed and operative in accordance with a preferred embodiment of the present invention, for routing or sorting mail based on markings affixed to the mail by the system of FIG. 1; and

FIG. 3 is a simplified flowchart illustration of a preferred method for using the system of FIGS. 1 and 2, operative in accordance with a preferred embodiment of the present invention.

### DETAILED DESCRIPTION OF PREFERRED EMBODIMENTS

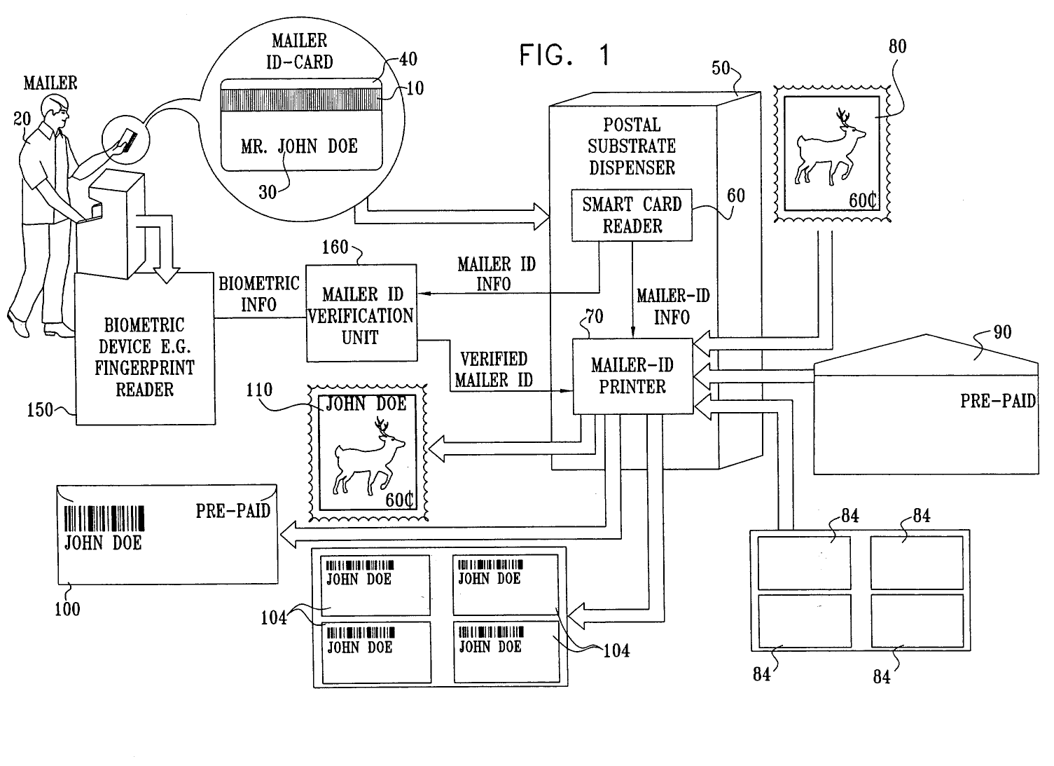

FIGS. 1-3 illustrate a system and method for automatic identification of a postal service user, also termed herein a “mailer”, constructed and operative in accordance with a preferred embodiment of the present invention. Specifically, FIG. 1 is a simplified block diagram of a mailer-ID marking system, constructed and operative in accordance with a preferred embodiment of the present invention, for affixing to a postal substrate a marking which identifies a mailer associated with the postal substrate.

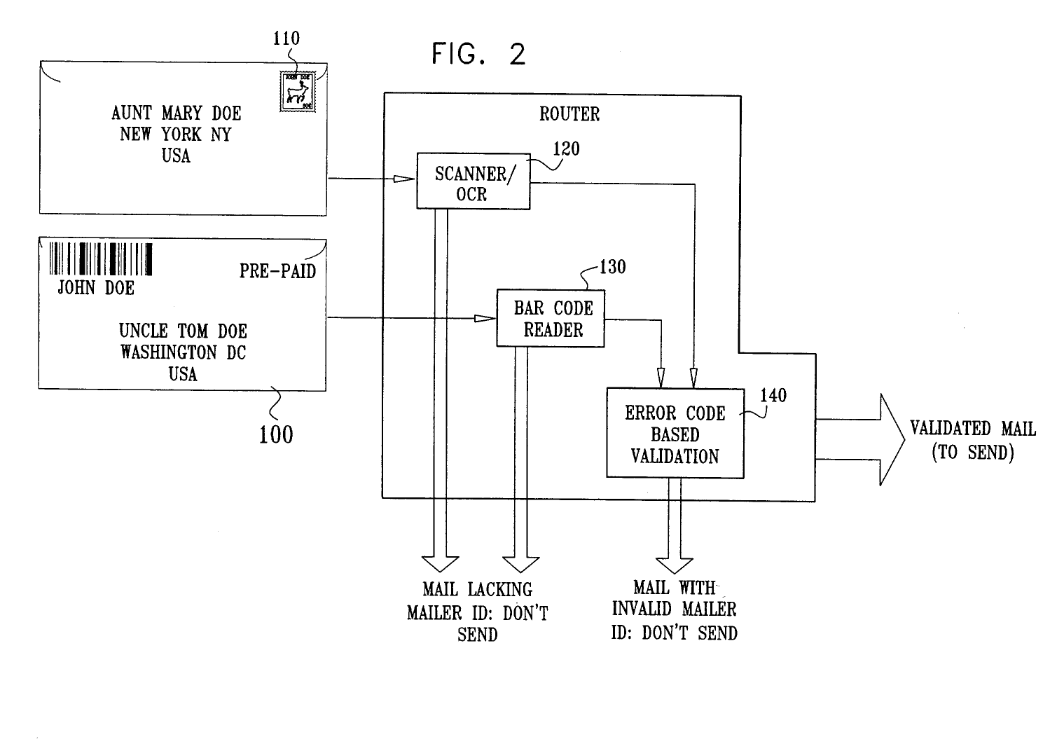

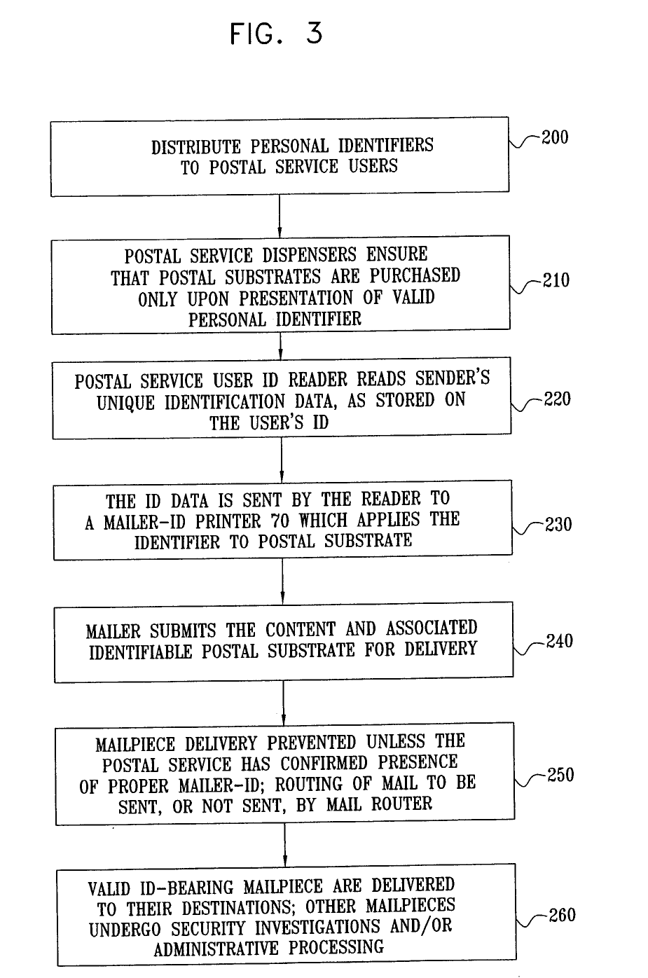

FIG. 2 is a simplified block diagram of a mail routing system, constructed and operative in accordance with a preferred embodiment of the present invention, for routing or sorting mail based on markings affixed to the mail by the system of FIG. 1. FIG. 3 is a simplified flowchart illustration of a preferred method for using the system of FIGS. 1 and 2, operative in accordance with a preferred embodiment of the present invention.

A preferred method for using the system of FIGS. 1-2 and the method of FIG. 3 to elicit, store and retrieve automatic identification of a postal service user, is now described with reference to FIGS. 1-3:

Step 200: Personal identifiers 10 are distributed to a population of postal service users 20. Each postal service user identifier 20 may include a portable substrate, such as a magnetic-stripe card or microprocessor-based smartcard, typically bearing a human-readable identification of a user 30 and/or a machine-readable identification 40 thereof. Alternatively, the personal identifiers employed by the system of the present invention may be based on existing identifiers already possessed by the population such as a social security card, driver's license, employer ID number (EID) or credit card.

Step 210: Postal service dispensers, human or machine, such as postal substrate dispenser 50 in FIG. 1, are instructed or programmed to ensure that postage stamps, postal labels, or prepaid envelopes are purchased only upon presentation of a valid physical personal identifier.

Step 220: Upon presentation of an identifier 10 by a potential mailer 20, a postal service user ID reader 60 is typically used to read the sender's unique identification data, as it is stored on the user's ID 10. For example, if the user's ID is stored on a smart card, the ID reader 60 may comprise a conventional smart card reader.

Step 230: The ID data is sent by the reader 60 to a Mailer-ID Printer 70 which applies the identifier, typically by imprinting, to a stamp 80, label 84, envelope 90, or other postal substrate which the user wishes to purchase. Alternatively, the identifier may be applied directly to a mailpiece which the user wishes to send. Imprinting may be ink-based, laser-applied, or may employ any other printing or identification technique, such as bar-code, radio frequency or memory chip technologies.

The imprinted or otherwise applied Mailer-ID uniquely identifies the sender, and optionally also identifies the time, date and location of delivery, along with other sender-specific data, depending on the needs that arise with system implementation. Optionally, Mailer-IDs are imprinted in human-comprehensible form on mailpieces, in a natural language, such as English, in order to inform mail recipients of the sender's identity. Alternatively, the Mailer-ID could comprise a humanly incomprehensible bar-code, a letter/number string, an encoded hence human-incomprehensible representation of human-comprehensible information, or any other suitable form of encoding.

Step 240: The resulting uniquely identifiable mailpiece 100, label 104 or postage stamp 110 is adhered or otherwise associated with content to be mailed, before submission of the content and associated identifiable postal substrate for delivery.

Step 250: As a regulatory measure, mailpiece delivery may be prohibited unless a postal substrate router 135 has confirmed the presence of a proper Mailer-ID e.g. using a state of the art scanner/OCR (optical character recognition) unit 120 or (if the mailer-ID is in bar-code form) a state of the art scanner/bar code reader 130. Routing of mail to be sent, or not sent, is carried out by router 135. Preferably, the router 135 checks not only for the presence of mailer-ID but also for the validity thereof.

Mailer ID-string validation may be implemented by any suitable method, such as the IEEE checksum method described in Fletcher, J. G., “An arithmetic checksum for serial transmissions,” IEEE Transactions on Communications, Vol. COM-30, No. 1, January 1982, pp. 247-252. Other suitable validation methods involve inclusion of control digits within Mailer-ID reference numbers thereby to allow validation by a conventional error-code based validation unit 140 and/or validation of biometric-based mailer-IDs (e.g., mailer-IDs based on fingerprint information) by comparing the mailer-ID to the relevant biometric characteristics of the individual presenting the mailer-ID.

Biometric comparisons are typically effected when postal substrates are purchased, using a conventional biometric reader 150 in conjunction with a biometric information comparison unit 160 which, verifies the mailer ID by comparing the ID received from smart card reader 60 to biometric information read from the mailer, as shown in FIG. 1.

Step 260: Valid ID-bearing mailpieces are then delivered to the appropriate recipient, using conventional postal service techniques. Invalid ID-bearing mailpieces, mailpieces not bearing an ID and mailpieces bearing a valid ID which nonetheless have been flagged for security reasons, are typically not delivered and instead are handled in accordance with security regulations formulated in accordance with the security situation and the constraints of the legal system.

Congress has empowered the Postal Service “to investigate postal offenses and civil matters relating to the Postal Service”. The Postal Inspection Service is the body within the US Postal Service authorized to conduct mail audits and inspection. As such, the Postal Inspection Service has the legal right to validate Mailer-ID tags of suspicious mailpieces before mail delivery. Mailer-ID validation is performed by a Mailer-ID Tracker device which reads and decodes the Mailer-ID as it is applied to the mailpiece.

The system shown and described herein has at least the following applications:

1. Preventing Bomb Mailing (18 USC 1716)—The US Postal Inspection Service claims that “the mailing of bombs is given one of [the] highest investigative priorities due to the severe impact it can have on postal customers, employees and operations”. The system shown and described herein makes mail-bombs more difficult to send and easier to track.

2. Preventing mail-based Child Exploitation (18 USC 1470, 2251, 2252, 2253, 2254, 2422, 2425)—Production and distribution of child pornography and other crimes exploiting children through the mail can be thwarted by identifying the senders of incriminating mailpieces.

3. Preventing Mailing of Controlled Substances (21 USC 841, 843 and 844)—Transporting and distributing narcotics through the mail or at postal facilities can similarly be tracked, and the perpetrators prosecuted.

4. Preventing Mail-based Extortion (18 USC 873, 876 and 877)—Extortion and blackmail demands for ransoms or rewards are often sent through the U.S. Mail. Identity of the senders of these threats and demands can be obtained by the system shown and described herein.

5. Preventing Mail-based Identity Fraud (18 USC 1028)—“Identity takeover” is a crime that often begins with the theft of mail or use of the mail to defraud individuals or financial institutions. The system shown and described herein makes identity takeovers by mail, virtually impossible.

6. Preventing Mail-based Obscenity and Sexually Oriented Advertising (18 USC 1461, 1463 and 1735; 39 USC 3010)—Obscenity standards prohibit “obscene, lascivious, indecent, filthy or vile” mailings. However, obscenity senders are currently free to operate because the US Postal Inspection Service has virtually no means of obtaining their identities. The system of the present invention allows postal inspection services to discover the identities of senders of obscene mail.

According to a preferred embodiment of the present invention, mail is accepted for sending only if it bears sender-identifying information in accordance with a preferred embodiment of the present invention. Further in accordance with a preferred embodiment of the present invention, mail bearing sender-identifying information is accepted for sending only if it bears sender-identifying information which has been verified e.g. by comparing the sender-identifying information to the individual presenting the postal substrate bearing the sender-identifying information. Any suitable human or automatic mechanism may be used for routing “accepted” mail to be sent and routing “unaccepted mail” to be returned to sender or to security handling. For example, conventional mechanisms for routing properly stamped mail for sending, while removing unstamped or understamped mail, may be employed.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A method for providing postal services comprising:
providing a postal substrate to a user, the postal substrate bearing an identification of the user; and
sending the postal substrate bearing the user's identification to a destination indicated by the user.

2. A method according to claim 1 wherein said postal substrate comprises one of the following postal substrates:
a postage stamp;
a postcard;
an airletter;
a prepaid envelope;
a mailing label; and
cardboard packaging.

3. A method according to claim 1 wherein the identification comprises human-readable identification information.

4. A method according to claim 1 wherein the identification comprises machine-readable identification information.

5. A method according to claim 1 wherein the identification comprises verifiable information and wherein said step of sending comprises accepting the postal substrate from an individual and verifying correspondence between the verifiable user's identification and said individual.

6. A method according to claim 5 wherein said verifiable information comprises “what you are” information.

7. A method according to claim 6 wherein said “what you are” information comprises biometric information.

8. A method according to claim 5 wherein said verifiable information comprises “what you have” information.

10. A method according to claim 5 wherein said verifiable information comprises “what you know” information.

11. A system for providing postal services comprising:
an ID-bearing postal substrate provider operative to provide a postal substrate bearing a user identification.

12. A system according to claim 11 and also comprising a postal substrate verifier operative to selectively authorize for sending, only postal substrates bearing verified user identification information.

13. A system according to claim 11 and also comprising a postal substrate validator and router operative to receive and validate postal substrates and to route for sending only postal substrates bearing valid user identification.

14. A system according to claim 11 wherein said postal substrate comprises one of the following postal substrates:
a postage stamp;
a postcard;
an airletter;
a prepaid envelope;
a mailing label; and
cardboard packaging.

15. A system according to claim 11 wherein the identification comprises human-readable identification information.

16. A system according to claim 11 wherein the identification comprises machine-readable identification information.

17. A system according to claim 11 wherein the identification comprises at least one of the following types of verifiable information:
“what you are” information;
biometric information;
“what you have” information; and
“what you know” information.
